(19) United States
(12) Patent Application Publication
(10) Pub. No.: US 2015/0097328 A1
(43) Pub. Date: Apr. 9, 2015

(54) WAFER HOLDING STRUCTURE

(71) Applicant: WIN Semiconductors Corp., Tao Yuan Shien (TW)

(72) Inventors: Yao-Hsien WANG, Tao Yuan Shien (TW); Yao-Chung HSIEH, Tao Yuan Shien (TW); I-Te CHO, Tao Yuan Shien (TW); Walter Tony WOHLMUTH, Tao Yuan Shien (TW)

(73) Assignee: WIN Semiconductors Corp., Tao Yuan Shien (TW)

(21) Appl. No.: 14/048,201

(22) Filed: Oct. 8, 2013

(51) Int. Cl. B23Q 1/03

(52) U.S. Cl. CPC B23Q 1/032
USPC 269/289 R

(57) ABSTRACT

A wafer holding structure for wafer backside processing, in which the wafer comprises a SiC substrate and a semiconductor device layer. The SiC substrate has a back surface and a front surface, and the semiconductor device layer has a first surface and a second surface. The semiconductor device layer is disposed on the SiC substrate with its first surface in contact with the front surface of the SiC substrate. The wafer holding structure comprises a wafer carrier and an adhesive coating. The wafer carrier is made of n-type conductive SiC, and has a thermal expansion coefficient that is well matched to the SiC substrate. The wafer carrier is mounted to the second surface of the semiconductor device layer and the adhesive coating is coated between the wafer carrier and the second surface of the semiconductor device layer.

### FIELD OF THE INVENTION

The present invention relates to a wafer holding structure, and more particular to a wafer holding structure for wafer backside processing of a wafer having a SiC substrate.

### BACKGROUND OF THE INVENTION

Silicon carbide (SiC) is chemically stable and has very high hardness. It has superior electrical and thermal conductivities, which makes it an ideal candidate for high power and high temperature applications. A semiconductor device fabricated on a SiC substrate can be used for in an environment which requires high heat and high radiation tolerance, such as various military and space applications like military radar, satellite, space telescopes, etc.

In wafer backside processes, the wafer is placed on a wafer holder with its backside facing upward and then transferred to processing equipments. The wafer should be remained well attached to the wafer holder during backside processes. However, the thermal properties of the SiC substrate are different from other III-V compound semiconductor material. Besides, the process temperature caused by etching the high hardness SiC is higher than conventional III-V compound semiconductor such as GaAs. Therefore, the inventors of the present invention provide a wafer holding structure to improve the wafer backside processing of a wafer having a SiC substrate.

### SUMMARY OF THE INVENTION

The main objective of the present invention is to provide a wafer holding structure for wafer backside processing, so that the warpage of the wafer can be reduced, the delamination of the wafer can be prevented, and the melting and reflow of the adhesion can be avoided during the backside processes.

To reach the objectives stated above, the present invention provides a wafer holding structure for wafer backside processing, in which the wafer comprises a SiC substrate and a semiconductor device layer. The SiC substrate has a back surface and a front surface, and the semiconductor device layer has a first surface and a second surface. The semiconductor device layer is disposed on the SiC substrate with its first surface in contact with the front surface of the SiC substrate. The wafer holding structure comprises a wafer carrier and an adhesive coating. The wafer carrier is made of n-type conductive SiC, and has a thermal expansion coefficient that is well matched to the SiC substrate. The wafer carrier is mounted to the second surface of the semiconductor device layer and the adhesive coating is coated between the wafer carrier and the second surface of the semiconductor device layer.

In implementation, the SiC substrate is semi-insulating.

In implementation, the SiC substrate is thinned to a thickness in a range of 25 to 150 micrometers.

In implementation, the semiconductor device layer comprises at east one epitaxial layer, each of which is made of GaN, AlGaN, AlN, or InGaN.

In implementation, the wafer carrier has a thermal conductivity of greater than 250 W/m/° C.

In implementation, the wafer carrier has a coefficient of linear thermal expansion greater than 2×10⁻⁶ m/° C.

In implementation, the wafer carrier has a thickness between 100 to 1000 micrometers with warpage of less than 50 micrometers.

In implementation, the softening temperature and melting temperature of the adhesive coating is higher than 100° C.

In implementation, the adhesive coating uses liquid wax.

The present invention will be understood more fully by reference to the detailed description of the drawings and the preferred embodiments below.

### BRIEF DESCRIPTION OF DRAWINGS

FIG. 1 is a cross-sectional view of a wafer holding structure for wafer backside processing according to an embodiment of the present invention.

FIG. 2 is a schematic showing the warpage measurement of a wafer carrier.

### DETAILED DESCRIPTIONS OF PREFERRED EMBODIMENTS

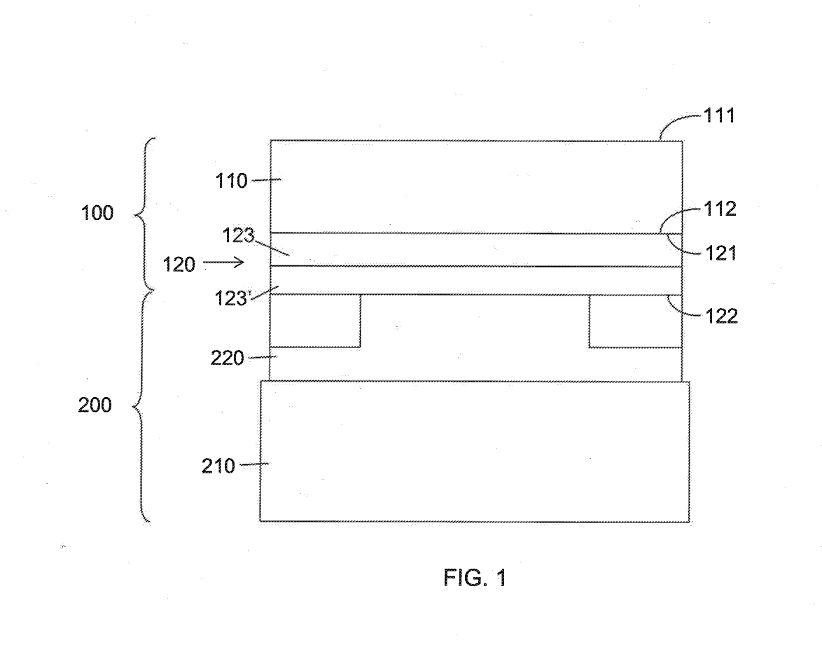

FIG. 1 is a schematic of a wafer holding structure for wafer backside processing according to an embodiment of the present invention. The wafer 100 comprises a SiC substrate 110 and a semiconductor device layer 120. The SiC substrate 110 has a back surface 111 and a front surface 112. The semiconductor device layer 120 has a first surface 121 and a second surface 122. The semiconductor device layer 120 is disposed on the SiC substrate 110 with its first surface 121 in contact with the front surface 112 of the SiC substrate 110. The wafer holding structure 200 comprises a wafer carrier 210 and an adhesive coating 220. The wafer carrier 210 is mounted to the second surface 122 of the semiconductor device layer 120 and the adhesive coating 220 is coated between the wafer carrier 210 and the second surface 122 of the semiconductor device layer 120.

In an embodiment of the present invention, the SiC substrate 110 is semi-insulating. To reduce the processing time, the SiC substrate 110 is first thinned before the wafer backside processing. The preferable thickness of the SiC substrate 110 is in a range of 25 to 150 micrometers. The semiconductor device layer 120 may comprise one or more epitaxial layers (123, 123′), each of which is made of GaN, AlGaN, AlN, or InGaN.

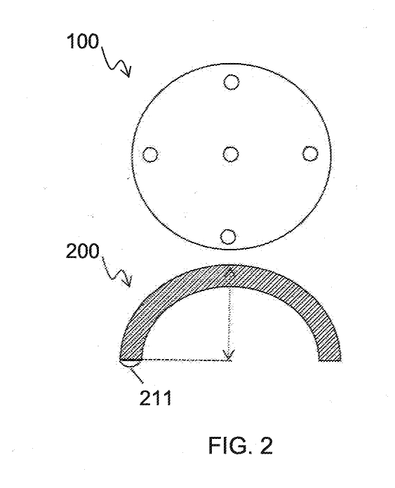

The preferable thickness of the wafer carrier provided by the present invention is between 100 to 1000 micrometers with warpage of less. than 50 micrometers. The warpage 211 is measured by a contact thickness meter, as shown in FIG. 2. The choice of the wafer carrier materials is crucial for the backside processing. The thermal expansion coefficient of the wafer carrier is preferably to be similar to the SiC wafer to prevent warpage of the wafer. The preferable coefficient of linear thermal expansion of the wafer carrier provided by the present invention is greater than 2×10⁻⁶ m/° C. Besides, a wafer carrier with good thermal conductivity can help to reduce the process temperature during the plasma etching process. The preferable thermal conductivity of the wafer carrier provided by the present invention is greater than 250 W/m/° C. Moreover, a conductive wafer carrier is preferred for the electrostatic clamp used in an inductively coupled plasma (ICP) etch tool, The n-type SiC is a conductive SiC, which has good thermal conductivity and similar coefficient of thermal expansion (CTE) to SiC. Therefore, the n-type conductive SiC is a preferable material for the wafer carrier according to an embodiment of the present invention.

The choice of the adhesive for the adhesive coating is another important issue for the backside processing. Poor adhesive between the wafer and the wafer carrier may cause wafer separation in the subsequent processes, and dewaxing of the adhesive coating maybe induce wafer delamination in the wafer thinning or other processes. Moreover, the adhesive may reflow during high temperature process such as ICP etching and sputtering. To prevent dewaxing and reflow of the adhesive, the adhesive used for the adhesive coating must have a high melting temperature. The softening temperature and melting temperature of the adhesive coating is preferably to be higher than 100° C. Besides, the adhesive coating must have high chemical resistance and can be removed easily. In an embodiment of the present invention, the adhesive coating uses liquid wax.

The present invention has the following advantages:

1. The wafer holding structure provided by the present invention has good thermal conductivity and similar coefficient of thermal expansion (CTE) to SiC, so that the warpage of the wafer with a SiC substrate due to the high temperature caused by the etching process can be reduced.

2. The wafer holding structure provided by the present invention is conductive and therefore can be used for the electrostatic clamp in ICP etch tool.

3. The wafer holding structure provided by the present invention use adhesive of high softening temperature and melting temperature for the adhesive coating, thereby the dewaxing of the adhesive can be prevent, and the reflow of the adhesion during sputtering can be avoided.

To sum up, the wafer holding structure provided by the present invention can indeed get its anticipated object to reduce the warpage of the wafer, to prevent the delamination of the wafer, and to avoid the melting and reflow of the adhesion during the backside processes. The product yield can therefore be improved.

The description referred to the drawings stated above is only for the preferred embodiments of the present invention. Many equivalent local variations and modifications can still be made by those skilled at the field related with the present invention and do not depart from the spirit of the present invention, so they should be regarded to fall into the scope defined by the appended claims.

What is claimed is:

1. A wafer holding structure for wafer backside processing, wherein the wafer comprises a SiC substrate having a back surface and a front surface and a semiconductor device layer having a first surface and a second surface, and the first surface of the semiconductor device layer is in contact with the front surface of the SiC substrate; the wafer holding structure comprising:
a wafer carrier, made of n-type conductive SiC, mounted to the second surface of the semiconductor device layer, and having a thermal expansion coefficient that is well matched to the SiC substrate; and
an adhesive coating coated between the wafer carrier and the second surface of the semiconductor device layer.

2. The wafer holding structure for wafer backside processing according to claim 1, wherein the SiC substrate is semi-insulating.

3. The wafer holding structure for wafer backside processing according to claim 1, wherein the SiC substrate is thinned to a thickness in a range of 25 to 150 micrometers.

4. The wafer holding structure for wafer backside processing according to claim 1, wherein the semiconductor device layer comprises at least one epitaxial layer, each of which is Made of GaN, AlGaN, AlN, or InGaN.

5. The wafer holding structure for wafer backside processing according to claim 1, wherein the wafer carrier has a thermal conductivity of greater than 250 W/m/° C.

6. The wafer holding structure for wafer backside processing according to claim 1, wherein the wafer carrier has a coefficient of linear thermal expansion greater than 2×10⁻⁶ m/° C.

7. The wafer holding structure for wafer backside processing according to claim 1, wherein the wafer carrier has a thickness between 100 to 1000 micrometers with warpage of less than 50 micrometers.

8. The wafer holding structure for wafer backside processing according to claim 1, wherein the softening temperature and melting temperature of the adhesive coating is higher than 100° C.

9. The wafer holding structure for wafer backside processing according to claim 1, wherein the adhesive coating uses liquid wax.
